(19) United States
(12) Patent Application Publication
(10) Pub. No.: US 2019/0199119 A1
(43) Pub. Date: Jun. 27, 2019

(54) VOLTAGE CONVERTER

(71) Applicant: Yazaki Corporation, Tokyo (JP)

(72) Inventor: Hideaki Kikuchi, Shizuoka (JP)

(21) Appl. No.: 16/211,174

(22) Filed: Dec. 5, 2018

(30) Foreign Application Priority Data
Dec. 21, 2017 (JP) 2017-244952

(51) Int. Cl. H02J 7/14

(52) U.S. Cl. CPC H02J 7/1423; B60L 11/1812

(57) ABSTRACT

A voltage converter includes a direct current power source composed of a plurality of secondary batteries, a first load driven by a first direct current voltage of the direct current power source, a voltage conversion unit that converts the first direct current voltage into a second direct current voltage and is driven by the second direct current voltage, a second load coupled to each of the secondary batteries via the voltage conversion unit, and a controller that watches a state of each of the secondary batteries. The voltage conversion unit includes a plurality of switches each of which is disposed between a positive electrode or a negative electrode of one of the secondary batteries and the second load. The controller switches the multiple switches on the basis of the state of each of the secondary batteries so as to apply the second direct current voltage to the second load.

### CROSS-REFERENCE TO RELATED APPLICATION(S)

The present application claims priority to and incorporates by reference the entire contents of Japanese Patent Application No. 2017-244952 filed in Japan on Dec. 21, 2017.

### BACKGROUND OF THE INVENTION

### 1. Field of the Invention

The present invention relates to a voltage converter.

### 2. Description of the Related Art

In accordance with trends in fuel economy regulation, mild hybrid electric vehicles (MHEVs) that assist engines by motor generators using 48 V direct current power sources have been put into practical use in recent years. As an example of power supply systems for the mild hybrid electric vehicles, Japanese Patent Application Laid-open No. 2014-187730, for example, discloses a power supply system in which a 48 V direct current power source and a 12 V direct current power source are coupled via a direct current DC/DC converter.

The conventional voltage converter, which uses the DC/DC converter to convert 48 V DC into 12 V DC, has room for improvement in terms of energy loss in the voltage conversion.

### SUMMARY OF THE INVENTION

A purpose of the present invention is to provide a voltage converter that can reduce energy loss in voltage conversion.

In order to achieve the above mentioned object, a voltage converter according to one aspect of the present invention includes a direct current power source that is composed of a plurality of secondary batteries; a first load that is driven by a first direct current voltage of the direct current power source; a voltage conversion unit that converts the first direct current voltage into a second direct current voltage smaller than the first direct current voltage; a second load that is coupled to each of the secondary batteries via the voltage conversion unit and is driven by the second direct current voltage; and a controller that watches a state of each of the secondary batteries and controls the voltage conversion unit, wherein the voltage conversion unit includes a plurality of switches each of which is disposed between a positive electrode or a negative electrode of one of the secondary batteries and the second load, each of the switches is capable of switching a state between the secondary battery and the second load between a conduction state and a non-conduction state, and the controller switches the switches on the basis of the state of each secondary battery so as to apply the second direct current voltage to the second load.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWING

FIG. 1 is a block diagram illustrating a schematic structure of a voltage converter according to an embodiment.

### DETAILED DESCRIPTION OF THE PREFERRED EMBODIMENT

The following describes an embodiment of a voltage converter according to the invention in detail with reference to the accompanying drawings. The following embodiment does not limit the invention. The constituent elements described in the following embodiment include those easily envisaged by those skilled in the art and substantially identical ones. The constituent elements in the embodiment can be omitted, replaced, or modified in various ways without departing from the scope of the invention.

### Embodiment

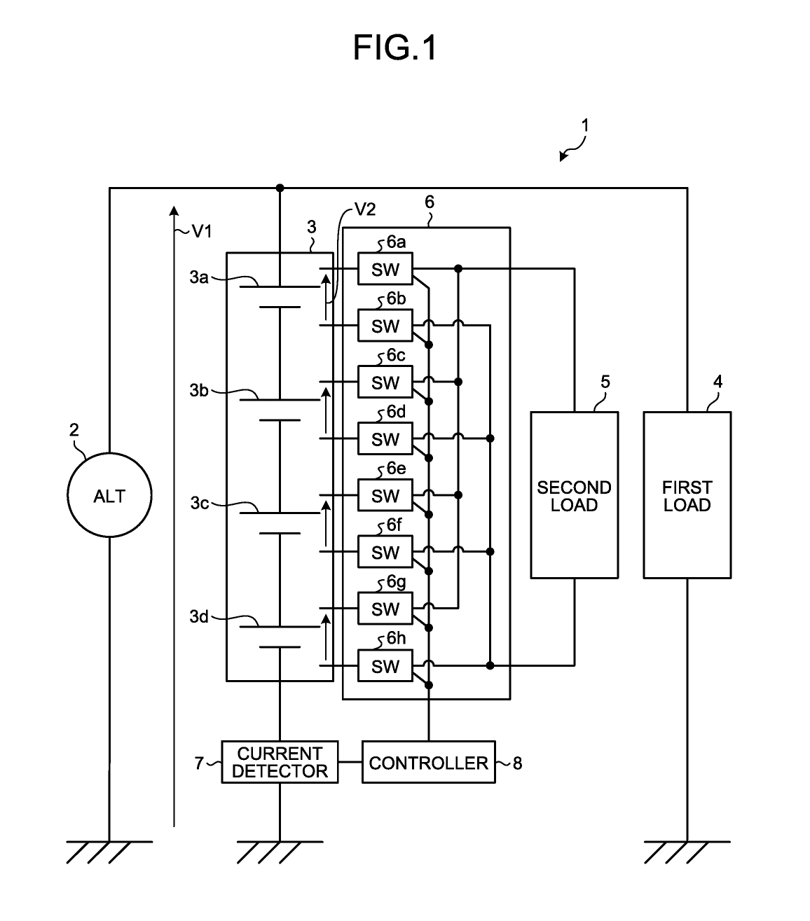

FIG. 1 is a block diagram illustrating a schematic structure of a voltage converter according to the embodiment.

This voltage converter 1 according to the embodiment is mounted on a vehicle such as a mild hybrid electric vehicle (MHEV) and can output various voltages from an assembled battery, for example. The mild hybrid electric vehicle is equipped with an assembled battery smaller than that of a typical hybrid electric vehicle (HEV) and a motor. The mild hybrid electric vehicle uses an engine as a main drive source and drives the motor by the assembled battery to assist the engine. As illustrated in FIG. 1, the voltage converter 1 in the embodiment includes an alternator 2, a direct current power source 3, a first load 4, a second load 5, a voltage conversion unit 6, a current detector 7, and a controller 8.

The alternator (ALT) 2 has a function as a generator that converts mechanical power into electrical power. The alternator 2 generates electrical power by converting power transferred from wheels and the engine of the vehicle, for example. The alternator 2 is connected to the direct current power source 3 and can charge the direct current power source 3.

The direct current power source 3 is an assembled battery for vehicles, for example. The direct current power source 3 is composed of a plurality of secondary batteries 3a, 3b, 3c, and 3d that are connected in series. The direct current power source 3 is connected to the first load 4 and applies a first direct current voltage V1 to the first load 4. The first direct current voltage V1 is 48 V, for example. Each of the secondary batteries 3a, 3b, 3c, and 3d is chargeable and dischargeable. For example, the second battery is a lithium-ion battery. Each of the secondary batteries 3a, 3b, 3c, and 3d is coupled to the second load 5 via the voltage conversion unit 6 and can apply a second direct current voltage V2 to the second load 5. The second direct current voltage V2 is lower than the first direct current voltage V1. For example, the second direct current voltage V2 is 12 V.

The first load 4 is connected to the direct current power source 3 and driven by the first direct current voltage V1 of the direct current power source 3. The first load 4 is a 48 V system load. Examples of the first load 4 include electric power steering, electric vehicle dynamics control (VDC), and an air conditioner that are mounted on the vehicle.

The second load 5 is coupled to each of the secondary batteries 3a to 3d via the voltage conversion unit 6 and driven by the second direct current voltage V2 of each of the secondary batteries 3a to 3d. The second load 5 is a 12 V system load. Examples of the second load 5 include headlights, audios, meters, stop lamps, direction indicators, and engine electric equipment that are mounted on the vehicle.

The voltage conversion unit 6 converts the first direct current voltage V1 into the second direct current voltage V2. The voltage conversion unit 6 includes a plurality of switches (SW) 6a, 6b, 6c, 6d, 6e, 6f, 6g, and 6h. Each of the switches 6a, 6b, 6c, 6d, 6e, 6f, 6g, and 6h is disposed between a positive electrode or a negative electrode of corresponding one of the secondary batteries 3a to 3d and the second load 5. One side of the switch 6a is connected to the positive electrode of the secondary battery 3a while the other side of the switch 6a is connected to the second load 5. One side of the switch 6b is connected to the negative electrode of the secondary battery 3a while the other side of the switch 6b is connected to the second load 5. One side of the switch 6c is connected to the positive electrode of the secondary battery 3b while the other side of the switch 6c is connected to the second load 5. One side of the switch 6d is connected to the negative electrode of the secondary battery 3b while the other side of the switch 6d is connected to the second load 5. One side of the switch 6e is connected to the positive electrode of the secondary battery 3c while the other side of the switch 6e is connected to the second load 5. One side of the switch 6f is connected to the negative electrode of the secondary battery 3c while the other side of the switch 6f is connected to the second load 5. One side of the switch 6g is connected to the positive electrode of the secondary battery 3d while the other side of the switch 6g is connected to the second load 5. One side of the switch 6h is connected to the negative electrode of the secondary battery 3d while the other side of the switch 6h is connected to the second load 5. Each of the switches 6a to 6h can switch a state between corresponding one of the secondary batteries 3a to 3d and the second load 5 between a conduction state and a non-conduction state. Each of the switches 6a to 6h causes the state to be in the conduction state when being turned on while each of the switches 6a to 6h causes the state to be in the non-conduction state when being turned off. Each of the switches 6a to 6h is connected to the controller 8. The controller 8 controls the tuning on or off of each of the switches 6a to 6h. Specifically, each of the switches 6a to 6h is turned on by an on signal from the controller 8 while each of the switches 6a to 6h is turned off by an off signal from the controller 8.

The current detector 7 is disposed between the direct current power source 3 and the ground. The current detector 7 detects a value of current flowing in the direct current power source 3. The current detector 7 includes an application specific integrated circuit (ASIC), which is a dedicated custom IC, for example. The current detector 7 is connected to the controller 8 and outputs the detected current value to the controller 8.

The controller 8 watches a state of each of the secondary batteries 3a to 3d and controls the voltage conversion unit 6. The controller 8 includes a microcomputer or a large scale integration (LSI), for example. The controller 8 has a function that watches a state of the direct current power source 3 on the basis of the current value output from the current detector 7, for example. The controller 8 is connected to the multiple switches 6a to 6h in the voltage conversion unit 6 and outputs the on signal or the off signal to control the turning on or off of each of the switches 6a to 6h. The controller 8 switches the multiple switches 6a to 6h on the basis of the state of each of the secondary batteries 3a to 3d so as to apply the second direct current voltage V2 to the second load 5.

The following describes switching operation of switches in the voltage converter 1 according to the embodiment. The operation is performed by a central processing unit (CPU) in the controller 8 executing a program read from a memory, for example.

Regardless when the alternator 2 charges the direct current power source 3 and the direct current power source 3 drives the first load 4, the controller 8 watches the state of the direct current power source 3 on the basis of the current value from the current detector 7. For example, the controller 8 preliminarily outputs the on signal to the switches 6g and 6h to cause the switches 6g and 6h to be in the on state and outputs the off signal to the switches 6a to 6f to cause the switches 6a to 6f to be in the off state. As a result, the second load 5 is driven by the second direct current voltage V2 of the secondary battery 3d.

When the current value from the current detector 7 is reduced, the controller 8 determines that uneven use occurs in the direct current power source 3, for example, and switches the switches 6a to 6h. For example, the controller 8 preliminarily outputs the off signal to the switches 6g and 6h to cause the switches 6g and 6h to be in the off state and outputs the on signal to the switches 6a and 6b to cause the switches 6a and 6b to be in the on state. As a result, the second load 5 is driven by the second direct current voltage V2 of the secondary battery 3a.

As described above, the voltage converter 1 according to the embodiment can easily take out different direct current voltages from the direct current power source 3 with a simple structure. The voltage converter 1 thus can reduce energy loss occurring in voltage conversion using a DC/DC converter. The voltage converter 1 according to the embodiment includes the direct current power source 3 composed of the multiple secondary batteries 3a to 3d. The voltage converter 1 thus can easily change the first direct current voltage V1 and the second direct current voltage V2 by combining the secondary batteries 3a to 3d. The voltage converter 1 according to the embodiment includes the first load 4 driven by the first direct current voltage V1, the voltage conversion unit 6 that converts the first direct current voltage V1 into the second direct current voltage V2, and the second load 5 that is coupled to each of the secondary batteries 3a to 3d via the voltage conversion unit 6 and is driven by the second direct current voltage V2. The voltage converter 1 thus can simultaneously drive the first load 4 and the second load 5 that are driven by different drive voltages. The voltage converter 1 according to the embodiment includes the voltage conversion unit 6 including the multiple switches 6a to 6h. Each of the switches 6a to 6h can switch the state between corresponding one of the secondary batteries 3a to 3d and the second load 5 between the conduction state and the non-conduction state. The voltage converter 1 thus can easily switch the connections between the respective secondary batteries 3a to 3d and the second load 5. The voltage converter 1 according to the embodiment includes the controller 8 that switches the multiple switches 6a to 6h on the basis of the state of each of the secondary batteries 3a to 3d so as to apply the second direct current voltage V2 to the second load 5. The voltage converter 1 thus can efficiently resolve the uneven use occurring in the direct current power source 3, thereby easily elongating the life-span of the direct current power source 3.

In the embodiment, the first direct current voltage V1 is 48 V while the second direct current voltage V2 is 12 V. The first direct current voltage V1 and the second direct current voltage V2 are not limited to the voltages. The first direct current voltage V1 and the second direct current voltage V2 are any voltages as long as the second direct current voltage V2 is smaller than the first direct current voltage V1. For example, the first direct current voltage V1 may be 48 V while the second direct current voltage V2 may be 24 V. For another example, the first direct current voltage V1 may be 24 V while the second direct current voltage V2 may be 12 V. When the first direct current voltage V1 is 48 V while the second direct current voltage V2 is 24 V, for example, the controller 8 switches the switches 6a to 6h so as to apply 24 V to the second load 5 (in this case, the second load 5 is a 24 V system load). For example, the controller 8 outputs the on signal to the switches 6a and 6d to cause the switches 6a and 6d to be in the on state and outputs the off signal to the switches 6b, 6c, and 6e to 6h to cause them to be in the off state.

In the embodiment, the direct current power source 3 is an assembled battery composed of four 12 V secondary batteries connected in series. The number of secondary batteries is not limited to four. The number of batteries may be two or more. For example, the direct current power source 3 may be an assembled battery composed of two 24 V secondary batteries connected in series.

In the embodiment, the alternator 2 is a generator that converts mechanical power into electrical power. The alternator 2 is not limited to the generator. The alternator 2 may be a motor generator that has a function of the generator and a motor function that converts supplied electrical power into mechanical power. The motor generator can be used as the alternator that generates electrical power by power transferred from wheels and the engine and as a starter motor that starts the engine by consuming electrical power supplied from the direct current power source 3. The motor generator may be used as a power source for running the vehicle.

In the embodiment, as a method of watching the state of the direct current power source 3, the current detector 7 detects the current value of the direct current power source 3. The method is not limited to this method. For example, the voltage converter 1 may include a plurality of voltage detectors each detecting a direct current voltage of one of the secondary batteries 3a to 3d. The state of each of the secondary batteries 3a to 3d may be watched on the basis of the voltage thereof detected by the corresponding voltage detector. In this case, each voltage detector outputs, to the controller 8, a voltage value of corresponding one of the secondary batteries 3a to 3d. The controller 8 determines the state of each of the secondary batteries 3a to 3d on the basis of the detected voltage value thereof.

The voltage converter according to the embodiment has an advantageous effect of capable of reducing energy loss in the voltage conversion.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A voltage converter comprising:
a direct current power source that is composed of a plurality of secondary batteries;
a first load that is driven by a first direct current voltage of the direct current power source;
a voltage conversion unit that converts the first direct current voltage into a second direct current voltage smaller than the first direct current voltage;
a second load that is coupled to each of the secondary batteries via the voltage conversion unit and is driven by the second direct current voltage; and
a controller that watches a state of each of the secondary batteries and controls the voltage conversion unit, wherein
the voltage conversion unit includes a plurality of switches each of which is disposed between a positive electrode or a negative electrode of one of the secondary batteries and the second load,
each of the switches is capable of switching a state between the secondary battery and the second load between a conduction state and a non-conduction state, and
the controller switches the switches on the basis of the state of each secondary battery so as to apply the second direct current voltage to the second load.
